(19) United States
(12) Patent Application Publication
(10) Pub. No.: US 2015/0076717 A1
(43) Pub. Date: Mar. 19, 2015

(54) TREATMENT PLANT FOR SEWAGE TREATMENT

(71) Applicant: XYLEM IP MANAGEMENT S.à r.I., Senningerberg (LU)

(72) Inventor: Lars Uby, Spanga (SE)

(21) Appl. No.: 14/389,070

(22) PCT Filed: Feb. 13, 2013
(86) PCT No.: PCT/SE2013/050123

§ 371 Date: Sep. 29, 2014

(30) Foreign Application Priority Data
Mar. 28, 2012 (SE) 1250307-4

(51) Int. Cl. C02F 3/22

(52) U.S. Cl. CPC C02F 3/22
USPC 261/121.1

(57) ABSTRACT

A treatment plant for waste water treatment, including a circulation tank, which is arranged to accommodate waste water up to a predetermined filling height, and at least one aerator section arranged at the bottom of the circulation tank, which aerator section is arranged to supply gas bubbles to the waste water, the circulation tank having a predetermined direction of flow along which the waste water is arranged to flow. The treatment plant includes a partition wall arranged transversely to the circulation tank downstream the aerator section, which partition wall has an upper end that in the vertical direction is situated at a height that is lower than 25% of the above-mentioned filling height.

### TECHNICAL FIELD OF THE INVENTION

The present invention relates generally to a treatment plant for waste water treatment. In particular, the present invention relates to a treatment plant for biological waste water treatment, the treatment plant comprising a circulation tank, which is arranged to accommodate waste water up to a predetermined filling height, and at least one aerator section arranged at the bottom of the circulation tank. The circulation tank has a predetermined direction of flow along which the waste water is arranged to flow, and the aerator section is arranged to supply gas bubbles to the waste water when the same passes the aerator section.

### BACKGROUND OF THE INVENTION AND PRIOR ART

A circulation tank, or oxidation ditch, is an open, endless tank that is used in biological purification, or oxidation, of waste water, in which the waste water is brought to flow along the circulation tank and thereby brought to pass different zones in the circulation tank. In such a biological purification, usually the waste water is cleaned from nitrogen and biological material by micro-organisms decomposing the biological material into carbon dioxide and water, and bacteria converting the waterborne nitrogen into aerial nitrogen. In case the waterborne nitrogen is not eliminated, this entails the risk of over-fertilization of watercourses and the biological material is strongly oxygen depleting, which gives watercourses deficient in oxygen, if untreated water is discharged. The decomposition of the biological material is stimulated by the supply of large amounts of oxygen to the waste water, and the elimination of the waterborne nitrogen occurs in areas in the circulation tank without supplied oxygen. Along the circulation tank, there are found at least one so-called aerated zone and at least one so-called non-aerated zone. Accordingly, the above-mentioned aerator section is arranged in the aerated zone.

In one, or a few, aerated zones along the circulation tank, oxygen is added to the waste water by gas bubbles being discharged into the waste water by means of aerator sections arranged at the bottom of the circulation tank. Microorganisms in the so-called activated sludge use the supplied oxygen to decompose the biological material found in the waste water.

Per definition, the waste water should circulate along the circulation tank, and a known attempt to provide a main liquid flow along the circulation tank and to simultaneously obtain uniform aeration of the waste water is disclosed in the withdrawn U.S. patent application Ser. No. 09/801,667. This patent application shows a plant that utilizes the lift of the air in order to create a main liquid flow. The waste water is entered into the aerator section in the vicinity of the bottom of the circulation tank and is discharged on the opposite side of the aerator section in the vicinity of the liquid surface; in this way, the liquid flow and the air flow have more or less the same direction above the aerator section. Accordingly, the main liquid flow is provided by the fact that a first transverse partition wall, arranged upstream the aerator section, extends down into the waste water from above the liquid surface and that a second transverse partition wall, arranged downstream the aerator section, extends up from the bottom of the circulation tank. It is important that the lower end of the first, upper partition wall is on a level that is situated below half the height of the circulation tank, and that the upper end of the second, lower partition wall is on a level that is situated above half the height of the circulation tank. In this way, a liquid flow past the aerator section is created, at the same time as the rise velocity of the air in the waste water is increased. A large disadvantage of the disclosed plant is thus that the supplied air will rise quickly to the surface and leave the waste water. A further disadvantage is that only the upper liquid volume downstream the aerator section will be provided with a flow rate along the circulation tank at the same time as the lower liquid volume will stand still, or recirculate slowly, downstream the aerator section, whereupon the biological material in the waste water risks being accumulated at the bottom of the circulation tank.

In a traditional circulation tank without such partition walls, there is found a strongly rearwardly directed return liquid flow closest to the bottom of the circulation tank, which rearwardly directed return flow is sucked into the aerator section and thereby creates an increased rise velocity of the supplied air. Accordingly, when considering the cross-section of the circulation tank, there are obtained differently directed liquid flows in a cross-section downstream the aerator section, more precisely a high flow rate along the circulation tank in the area of the liquid surface and a rearwardly directed flow at the bottom of the circulation tank.

### BRIEF DESCRIPTION OF THE OBJECTS OF THE INVENTION

The present invention aims at obviating the abovementioned disadvantages and failings of previously known treatment plants and at providing an improved treatment plant. A primary object of the invention is to provide an improved treatment plant of the initially defined type, which provides a more uniform main liquid flow along the circulation tank when considering a cross-section of the circulation tank downstream the aerator section.

### BRIEF DESCRIPTION OF THE FEATURES OF THE INVENTION

According to the invention, at least the primary object is achieved by the initially defined treatment plant having the features defined in the independent claims. Preferred embodiments of the present invention are furthermore defined in the depending claims.

According to the present invention, a treatment plant of the type initially defined is provided, which is characterized in that the same comprises a partition wall arranged transversely to the circulation tank downstream the aerator section, which partition wall has an upper end that in the vertical direction is situated at a height that is lower than 25% of the predetermined filling height of the circulation tank.

Accordingly, the present invention is based on the understanding that a low partition wall arranged downstream the aerator section stops the rearwardly directed return liquid flow found closest to the bottom of the circulation tank in the area downstream the aerator section, with the purpose of lowering the rise velocity of the air and with the purpose of recovering the linear momentum of the rearwardly directed return flow by means of the reaction force of the partition wall on the waste water, which strengthens the main liquid flow, at the same time as the main liquid flow that passes the aerator section along the circulation tank is affected to an as small as possible extent.

According to a preferred embodiment of the present invention, the upper end of the partition wall in the vertical direction is situated at a height that is less than 20% of the filling height, preferably less than 15%.

According to a preferred embodiment, the partition wall has a lower end that in the vertical direction is situated at a distance from the bottom of the circulation tank. Preferably, the distance between the lower end of the partition wall and the bottom of the circulation tank is more than 5 cm and less than 15 cm. This entails that solid material found in the waste water does not risk being accumulated at the partition wall but can pass freely under the same.

Preferably, the partition wall has a first surface turned downstream, which first surface is plane. In a further preferred embodiment, the first surface of the partition wall is essentially vertical. A plane and vertical surface of the partition wall turned downstream gives maximum effective target area in relation to the rearwardly directed return liquid flow with a minimal size of the partition wall. Further, the partition wall has a second surface turned upstream, which second surface is curved in the upstream direction, with the purpose of minimizing the effect on the main liquid flow that passes the aerator section along the circulation tank.

In a further preferred embodiment, the treatment plant comprises at least one flow generating machine arranged upstream said at least one aerator section, which flow generating machine is arranged to generate the main liquid flow along said circulation tank.

Additional advantages and features of the invention are seen in the other dependent claims as well as in the following, detailed description of preferred embodiments.

### BRIEF DESCRIPTION OF THE DRAWINGS

A more complete understanding of the above-mentioned and other features and advantages of the present invention will be clear from the following, detailed description of preferred embodiments, reference being made to the accompanying drawings, wherein:

FIG. 1 is a schematic elevated view from above of a treatment plant according to the invention,

FIG. 2 is a schematic side view of the aerator section and partition wall of the treatment plant,

FIG. 3 is a schematic cross-sectional view of the partition wall of the treatment plant according to a first embodiment,

FIG. 4 is a schematic cross-sectional view of the partition wall of the treatment plant according to a second embodiment, and

FIG. 5 is a schematic cross-sectional view of the partition wall of the treatment plant according to a third embodiment.

### DETAILED DESCRIPTION OF PREFERRED EMBODIMENTS

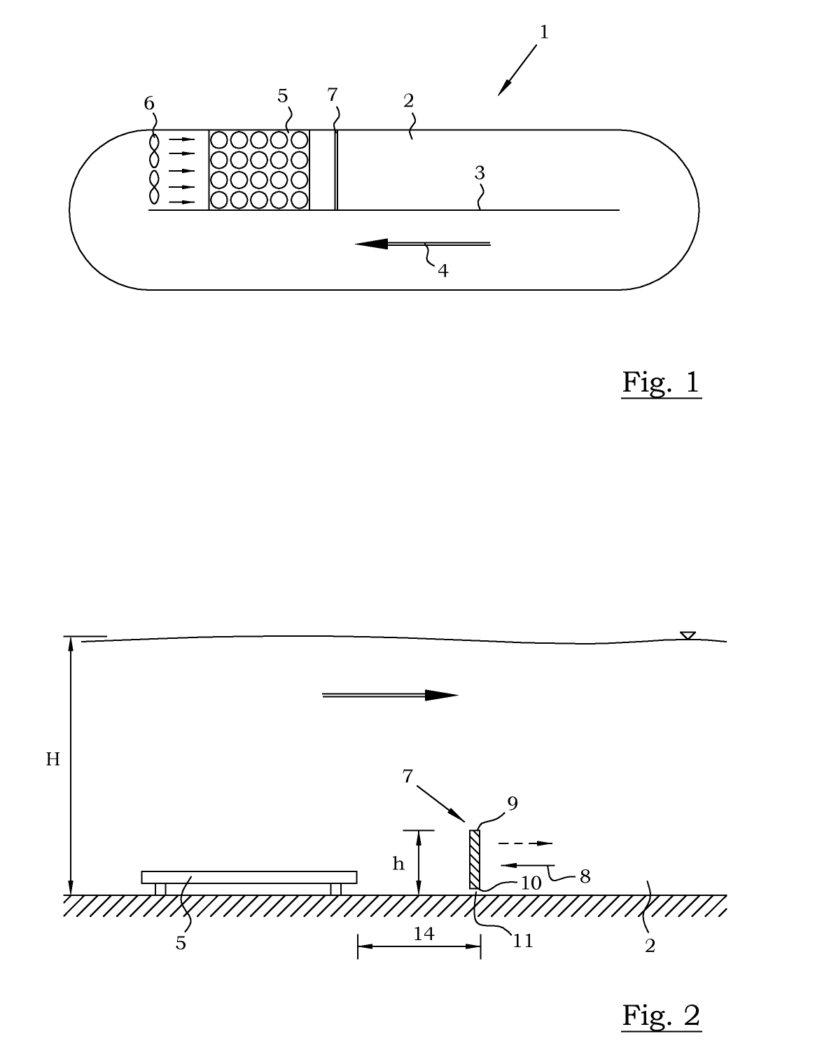

Reference is initially made to FIGS. 1 and 2. The present invention relates to a treatment plant, generally designated 1, for waste water treatment comprising biological material. The treatment plant comprises an endless circulation tank 2, or oxidation ditch, which in the embodiment shown consists of an elongate tank having rounded ends and comprising a centrally placed longitudinal partition 3, whereupon the circulation tank 2 obtains two parallel and straight channel segments that are connected to each other by two redirecting/semicircular channel segments. It should be pointed out that circulation tanks may have other feasible shapes, for instance an annular shape or a serpentine shape; accordingly, the circulation tank may comprise more straight and redirecting channel segments, respectively, or have an entirely circular/elliptical path shape. The circulation tank 2 is arranged to accommodate waste water up to a predetermined filling height H, even if the actual liquid level in operation may be below as well as exceed said filling height H without the present invention being affected. The waste water is cleaned batch-wise, or continuously, in a treatment plant 1 according to the invention, and with a waste water volume that reaches up to said filling height H, an optimal utilization of the treatment plant 1 is obtained. A typical filling height H is in the order of 3-4 m, but can be as high as 7-8. The circulation tank 2 is arranged with a predetermined direction of flow, schematically illustrated by means of the arrow 4, along which the waste water is intended to flow, while forming a main liquid flow. According to the invention it is of secondary importance how the main liquid flow is obtained, as long as there is a predetermined direction of flow in the circulation tank 2.

Further, the treatment plant 1 according to the invention comprises at least one aerator section 5 that is arranged in an aerated zone of the circulation tank 2. Upstream the aerator section 5, there is found a non-aerated zone of the circulation tank 2. In the embodiment shown, the aerator section 5 is arranged in the beginning of a straight channel segment, even if other positions are feasible. Said at least one aerator section 5 is arranged at the bottom of the circulation tank 2 and is arranged to supply oxygen-containing gas bubbles, such as air or pure oxygen, to the waste water, with the purpose of supplying oxygen to the waste water. The aerator section 5 consists, for instance, of a vast number of diffusers or aerator elements, which jointly cover the entire or the main part of the width of the circulation tank 2, a typical width of the circulation tank 2 is in the order of 10-15 m. The length of the aerator section 5 along the circulation tank 2 is in the order of 5-25% of the entire length of the circulation tank 2. Preferably, the treatment plant 1 comprises two or more aerator sections 5, which preferably are equidistantly arranged along the circulation tank 2.

In a preferred embodiment, the treatment plant 1 comprises at least one flow generating machine 6 arranged upstream said at least one aerator section 5. The flow generating machine 6 is arranged to generate a flow of waste water along said circulation tank 2, and may consist of one or more so-called slow-moving agitators. Preferably, the treatment plant 1 comprises flow generating machines 6 in two or more positions, which preferably are equidistantly arranged along the circulation tank 2.

The treatment plant according to the invention comprises also at least one partition wall 7 arranged transversely to the circulation tank 2 downstream said at least one aerator section 5. In the description as well as in the appended claims, by the expression “transversely to the circulation tank”, reference is made to the fact that the partition wall 7 extends transversely to the direction of flow 4 of the circulation tank 2. Preferably, the partition wall 7 is arranged perpendicular to the direction of flow 4 of the circulation tank 2. The purpose of the partition wall 7 is to prevent a rearwardly directed return flow, schematically illustrated by means of the arrow 8, at the bottom of the circulation tank 2. When the rearwardly directed return flow 8 meets the partition wall 7, the same is redirected without having influenced the operation of the aerator section 5. In other words, a reaction force is exerted from the partition wall 7 on the waste water, which strengthens the main liquid flow.

The partition wall 7 has an upper end 9 that in the vertical direction is situated at a height h that is situated lower than 25% of the predetermined filling height H of the circulation tank. Preferably, the upper end 9 of the partition wall 7 in the vertical direction is situated at a height h that is lower than 20% of the filling height H, more preferably lower than 15%. A typical height H is in the order of 0.5 m.

Further, the partition wall 7 has a lower end 10 that in the vertical direction preferably is situated at a distance 11 from the bottom of the circulation tank 2. It is further preferred that the distance 11 between the lower end 10 of the partition wall 7 and the bottom of the circulation tank 2 is more than 5 cm and less than 15 cm. The purpose of arranging the partition wall 7 with a distance between the lower end 10 of the partition wall 7 and the bottom of the circulation tank 2 is to prevent solid material from being accumulated at the partition wall 7.

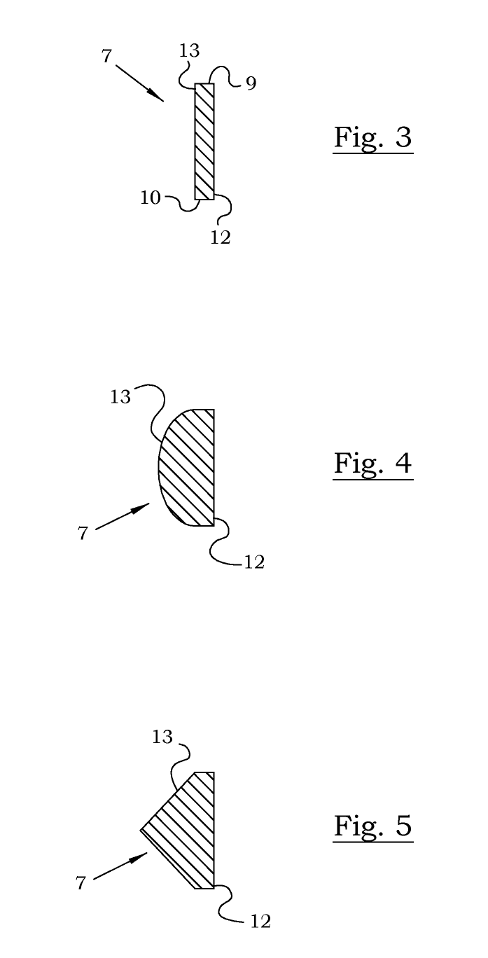

Now, reference is made primarily to FIGS. 3-5, which show different embodiments of the partition wall 7 according to the invention. The partition wall 7 has a first surface 12 turned downstream and a second surface 13 opposite the first surface and turned upstream.

According to a preferred embodiment, said first surface 12 is plane; in addition, it is preferred that the first surface 12 is inclined less than 45° in relation to a vertical line. Most preferably, the first surface 12 of the partition wall 7 should be essentially vertical, with the purpose of having as large effective surface as possible in relation to the rearwardly directed return flow 8. It should be appreciated that the partition wall 7 may be divided into several partition wall segments (not shown) arranged beside each other, which may have different mutual angular orientation in relation to a vertical line, with the purpose of optimizing the partition wall 7 in relation to non-uniform rearwardly directed return flow as viewed transversely to the bottom of the circulation tank 2.

The second surface 13 of the partition wall 7 may also be plane, like the first surface 12, and is in this case preferably parallel to said first surface 12, according to FIG. 3. Alternatively, the second surface 13 may incline in the direction downstream (not shown), i.e., in the direction away from the aerator section 5, preferably less than 45° in relation to a vertical line. However, it is preferred that the second surface 13 is curved, or non plane, and has some kind of bulging in the upstream direction. In FIG. 4, there is shown a curved second surface 13 of the partition wall 7 in the form of a curvature having an arched, or semicircular, cross-section, and in FIG. 5, there is shown a curved second surface 13 of the partition wall 7 in the form of a curvature having a triangular, or acute, cross-section. It should be pointed out that the cross-section of the second surface 13 alternatively may have other shapes than those shown, for instance a polygonal cross-section. The curved shape of the second surface 13 of the partition wall 7 entails that the effect of the partition wall 7 on the main liquid flow 4 can be minimized.

Now, reference is made again to FIG. 2. The partition wall 7 should be situated at a distance from the aerator section 5. According to the preferred embodiment, the first surface 12 of the partition wall 7 in the area of the lower end 10 of the partition wall 7 should be situated at a distance 14 from the aerator section 5 that is less than two times the filling height H. Preferably, said distance should be less than the filling height H, more preferably less than 25% of the filling height H. A rearwardly directed return flow between the partition wall 7 and the aerator section 5 is thereby prevented from being generated.

### Feasible Modifications of the Invention

The invention is not limited only to the embodiments described above and shown in the drawings, which only have the purpose of illustrating and exemplifying. This patent application is intended to cover all adaptations and variants of the preferred embodiments described herein, and consequently the present invention is defined by the wording of the accompanying claims and accordingly, the equipment may be modified in all feasible ways within the scope of the accompanying claims.

It should also be pointed out that all information about/regarding terms such as above, below, upper, under, etc., should be interpreted/read with the equipment orientated in accordance with the figures, with the drawings orientated in such a way that the reference designations can be read in a proper way. Accordingly, such terms only indicate mutual relationships in the shown embodiments, which relationships may be changed if the equipment according to the invention is provided with another construction/design.

It should be pointed out that even if it is not explicitly mentioned that features from one specific embodiment can be combined with the features of another embodiment, this should be regarded as evident when possible.

1. A treatment plant for waste water treatment, comprising a circulation tank, which is arranged to accommodate waste water up to a predetermined filling height (H), and at least one aerator section arranged at a bottom of the circulation tank, which aerator section is arranged to supply gas bubbles to the waste water, the circulation tank having a predetermined direction of flow along which the waste water is arranged to flow, wherein the treatment plant further comprises a partition wall arranged transversely to the circulation tank downstream the aerator section, which partition wall has an upper end that in the vertical direction is situated at a height (h) that is lower than 25% of the predetermined filling height (H).

2. The treatment plant according to claim 1, wherein the upper end of the partition wall in the vertical direction is situated at the height (h) that is lower than 20% of the filling height (H).

3. The treatment plant according to claim 1, wherein the partition wall has a lower end that in the vertical direction is situated at a distance from the bottom of the circulation tank.

4. The treatment plant according to claim 3, wherein the distance between the lower end of the partition wall and the bottom of the circulation tank is more than 5 cm and less than 15 cm.

5. The treatment plant according to claim 1, wherein the partition wall has a planar first surface facing downstream.

6. The treatment plant according to claim 5, wherein the first surface of the partition wall is inclined less than 45 degrees in relation to a vertical line.

7. The treatment plant according to claim 5, wherein the first surface of the partition wall is substantially vertical.

8. The treatment plant according to claim 5, wherein the partition wall has a second surface facing upstream, which second surface is curved in the upstream direction.

9. The treatment plant according to claim 5, wherein the first surface of the partition wall in the area of the lower end of the partition wall is situated at a distance from the aerator section, which distance is less than two times the filling height (H).

10. The treatment plant according to claim 9, wherein the distance between the aerator section and the first surface of the partition wall in the area of the lower end of the partition wall is less than the filling height (H).

11. The treatment plant according to claim 1, wherein the treatment plant comprises at least one flow generating machine arranged upstream said at least one aerator section, which flow generating machine is arranged to generate a flow of waste water along said circulation tank.

12. A treatment plant for waste water treatment, comprising:
a circulation tank configured to accommodate waste water to a predetermined filling height relative to a bottom of the circulation tank, the circulation tank having a predetermined waste water flow direction;
at least one aerator section at the bottom of the circulation tank for supplying gas bubbles to the waste water;
a partition wall transverse to the waste water flow and downstream of the aerator section, the partition wall having an upper end, a lower end, an upstream surface, and a downstream surface, wherein the partition wall upper end has a height relative to the circulation tank bottom that is lower than 25% of the filling height, and the partition wall lower end is spaced from the bottom of the circulation tank.

13. The treatment plant of claim 12, wherein the downstream surface of the partition wall is substantially planar.

14. The treatment plant of claim 12, wherein the upstream surface of the partition wall has a non-planar configuration that bulges toward the aerator section.

15. The treatment plant of claim 14, wherein the upstream surface is has an arched cross-sectional geometry.

16. The treatment plant of claim 15, wherein the upstream surface has triangular cross-sectional geometry.

17. The treatment plant of claim 12, wherein the distance between the lower end of the partition wall and the bottom of the circulation tank is more than 5 cm and less than 15 cm.

18. The treatment plant of claim 17, wherein the lower end downstream surface of the partition wall is spaced less than two times the filling height from the aerator section.

19. The treatment plant of claim 18, wherein the partition wall upper end height is lower than 20% of filling height and the lower end downstream surface of the partition wall is spaced less than the filling height from the aerator section.

20. The treatment plant of claim 12, wherein the treatment plant further comprises at least one flow generating machine upstream of said at least one aerator section.
